(19) United States
(12) Patent Application Publication
(10) Pub. No.: US 2012/0070640 A1
(43) Pub. Date: Mar. 22, 2012

(54) FLOOR TREATMENT METHOD

(76) Inventor: George Wakalopulos, Pacific Palisades, CA (US)

(21) Appl. No.: 13/238,583

(22) Filed: Sep. 21, 2011

Related U.S. Application Data
(60) Provisional application No. 61/384,815, filed on Sep. 21, 2010.

(51) Int. Cl. C08J 7/18; B32B 9/00; B32B 7/02

(52) U.S. Cl. 428/213; 427/553; 428/411.1

(57) ABSTRACT

A method of treating a floor involves first applying a release layer to the floor, then applying a UV-curable coating above the release layer and curing it by exposure to UV radiation, e.g. by means of UV lamps supported in plane above the floor by a portable floor machine. The release layer serves as a sacrificial layer enabling easy removal of the coating, e.g. by power scrubbing with hot water, after which a new release layer and UV-curable coating can be applied.

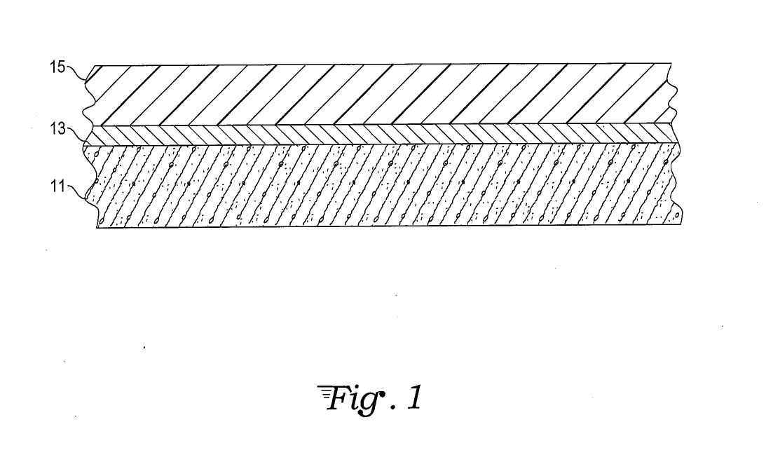

### CROSS-REFERENCE TO RELATED APPLICATION

The present application claims priority under 35 U.S.C. 119(e) from prior U.S. Provisional Application No. 61/384,815, filed Sep. 21, 2010.

### TECHNICAL FIELD

The present invention relates to equipment, materials and methods for the application, treatment or removal of floor coatings.

### BACKGROUND ART

Industrial floors are often made of concrete or asphalt tile. Wax, paint, polymers or other coatings are applied to protect the floor. In recent years, UV-curable coatings have become popular, because they are relatively easy to apply and tough. However, subsequent removal, when needed, is also difficult.

It would be desirable if UV-curable coatings were available that are both easy to apply and remove.

### SUMMARY DISCLOSURE

The present invention is a floor treatment method that involves applying a release layer to a floor as a sacrificial coating immediately below a UV-curable coating. First the release layer is applied to the floor. Then, the UV-curable coating is applied to the floor over the release layer. Finally, the UV-curable coating is cured by exposure to UV radiation. This exposure can be accomplished by directing UV light from a beam source that is supported for motion (e.g., circular motion) in a plane less than 25 cm (10 inches) above the floor.

In normal use, the cured coating is durable. But when desired, the coating along with the underlying release layer can be removed. Preferably, the release layer is one that is soluble in hot water under pressure, so that the removal of the coating and release layers can be obtained by power washing, i.e. by applying hot water and scrubbing.

### BRIEF DESCRIPTION OF THE DRAWINGS

The drawing FIGURE is a side sectional view of a floor that has been coated in accordance with the present invention.

### DETAILED DESCRIPTION

As seen in the Figure, a sacrificial release layer 13 is present over a floor 11. A UV-curable coating 15 lies over the release layer 13.

The release layer 13 is preferably hot-water soluble, such as that described in U.S. Pat. No. 5,387,434 to Black. Other sacrificial release layers include those described in U.S. Pat. No. 5,750,269 to Park (soluble in hot water or steam) or in U.S. Pat. No. 4,349,586 to Sejournant (soluble in a mixture of warm water and 5% kerosene). Release layers that are not water soluble in hot water may be also be used. A suitable commercial product is Monochem Permashield® Sacrificial Graffiti Control System available from Monopole, Inc. of Los Angeles, Calif. USA. This coating is primarily designed for treating surfaces to facilitate removal of graffiti, by forming a barrier over the surface that can later be removed along with any graffiti by means of a power washer using hot water. In the present invention, the UV-curable floor coating substitutes for the graffiti, but the release principle is the same.

The release layer material is preferably clear, so that the overlying UV-coating 15 will dominate the appearance, if pigmented, on allow the natural color of the floor 11 to come through, if also clear. While it is possible for the release layer 13 to be pigmented, since that layer is hot-water soluble, pigmentation is usually the role of the overlying UV-curable coating 15.

The UV-curable coating layer 15 may be applied over the release layer in various ways, but a preferred way is to use a floor machine that simultaneously applies and cures the coating in linear swaths. The coating 15 may be a series of very thin (less than 25 μm thick) cured coating layers, applied one atop the other to achieve a desired overall thickness. A dispenser associated with the floor machine can be used to apply the release layer, then later apply the UV coating, using rollers. Alternatively, the release layer and later the UV-curable coating material may be applied with a separate machine from the UV curing machine. A preferred floor machine for curing the UV coating is the Circa 2000 floor machine available from Adastra Technologies Inc. of Torrance, Calif. USA, which is a portable machine (less than 18 kg or 40 lb.) that operates with 110/220V AC input and that cures coatings in 50 cm (20 inch) wide linear swaths by a rotation of UV lamps less than a few centimeters from the floor.

1. A method of treating a floor, comprising:
applying a release layer to the floor;
applying a UV-curable coating over the release layer; and
curing the coating by exposure to UV radiation.

2. A method as in claim 1, wherein the release layer is water soluble.

3. A method as in claim 2, further comprising subsequently removing the coating along with the release layer by power washing, then repeating the steps of claim 1 to form a new release layer and coating.

4. A method as in claim 3, wherein the power washing includes applying hot water and scrubbing.

5. A method as in claim 1, wherein curing the coating includes directing UV light from a source that is supported for motion in a plane less than 25 cm above the floor.

6. A method as in claim 1, wherein the release layer is clear.

7. A method as'in claim 1, wherein the UV-curable coating is pigmented.

8. A method as in claim 1, wherein the UV-curable coating is clear.

9. A method as in claim 1, wherein the steps of applying a UV-curable coating and curing the coating are repeated multiple times to form a series of thin coating layers each less than 25 μm thick and disposed one atop the other to a specified overall thickness.

10. A floor having a release layer thereon and a UV-cured coating over the release layer.

11. A floor as in claim 10, wherein the release layer is soluble in hot water.

12. A floor as in claim 10, wherein the UV-cured coating comprises a series of thin coating layers each less than 25 μm thick and disposed one atop the other to a specified overall thickness.

13. A method as in claim 1, wherein the release layer is clear.

14. A method as in claim 10, wherein the UV-cured coating is pigmented.

15. A method as in claim 10, wherein the UV-cured coating is clear.
